(19) United States
(12) Patent Application Publication
(10) Pub. No.: US 2020/0034120 A1
(43) Pub. Date: Jan. 30, 2020

(54) SYSTEM AND METHOD FOR VISUALLY SPECIFYING COMPUTATION SEQUENCES AND RESULTS

(71) Applicant: Nicholas Hoff, Berlin (DE)

(72) Inventor: Nicholas Hoff, Berlin (DE)

(21) Appl. No.: 16/494,793

(22) PCT Filed: Mar. 16, 2018
(86) PCT No.: PCT/US18/22781

§ 371 Date: Sep. 17, 2019

Related U.S. Application Data
(60) Provisional application No. 62/472,618, filed on Mar. 17, 2017.

(51) Int. Cl. G06F 8/34; G06F 9/44; G06F 8/38; G06F 3/0481

(52) U.S. Cl. CPC G06F 8/34; G06F 9/44; G06F 2203/04806; G06F 3/0481; G06F 8/38

(57) ABSTRACT

A computer-based visual programming system has a user interface, with visual elements that appear at a computer screen and enable a user to: draw a plurality of blocks on a screen of the computer device, with each block having an associated functionality, and draw one or more lines to selectively connect the blocks together, thereby, creating a graphical representation of a computational sequence on the computer screen. The lines determine an order for performing the functionalities associated with the blocks. A computer-based evaluator is coupled to the computer-based user interface and configured to evaluate the graphical representation of the computational sequence so that one or more results from the computational sequence can be returned to the computer-based user interface for display on the computer screen. The user interface visually displays the results on the computer screen, e.g., inside or adjacent to a corresponding one of the blocks.

CROSS-REFERENCE TO RELATED APPLICATION(S)

This application claims the benefit of U.S. Provisional Patent Application No. 62/472,618, filed Mar. 17, 2017, entitled System and Method for Visually Specifying Computation Sequences and Results. The contents of the prior application are incorporated by reference herein.

### FIELD OF THE INVENTION

This disclosure relates to a computer-based system and associated method(s) for visually specifying computation sequences and results.

### BACKGROUND

A computer program specifies a sequence of computations, conditions, and other actions, as well as a set of desired results. The program is usually expressed in a text-based programming language, which can be cumbersome, complex, difficult to use and difficult to understand.

### SUMMARY OF THE INVENTION

In one aspect, a computer-based visual programming system includes a computer-based user interface, which may include, for example, one or more screens, pages, and/or visual elements—like buttons and icons—that appear at a computer screen and enable a user to interact with and/or access the computer system and computer-based functionalities disclosed herein. More particularly, the system enables a user at a computer device to: draw a plurality of blocks on a screen of the computer device, with each block having an associated functionality, and draw one or more lines to selectively connect the blocks together, thereby, creating a graphical representation of a computational sequence on the computer screen. The lines determine an order for performing the functionalities associated with the blocks. A computer-based evaluator is coupled to the computer-based user interface and configured to evaluate the graphical representation of the computational sequence so that one or more results from the computational sequence can be returned to the computer-based user interface for display on the computer screen. In a typical implementation, the user interface visually displays each respective one of the results from the computational sequence on the computer screen, and in association with (e.g., inside or adjacent to) a corresponding one of the blocks.

In some implementations, the system/computer-based user interface further enables the user at the computer device to: organize two or more of the blocks on the computer screen into a composite block, and link the two or more blocks in the composite block together. The composite block has a composite functionality that combines the functionalities of the blocks inside the composite block. In a typical implementation, the blocks in the composite block can be nested or encapsulated to any degree (e.g., can include any number of blocks and can include any number of levels of blocks inside of blocks).

In some implementations, the evaluator has a computer-based compiler that translates the graphical representation of the computational sequence into software code in a target language. The software code in the target language may be executed in a target-language execution environment (of processor(s) and software configured to execute) to produce the one or more results.

In some implementations, the evaluator has a computer-based interpreter that interprets the graphical representation of the computational sequence, directly, without translating the graphical representation into software code of a target language. The direct interpretation typically produces the one or more results.

In some implementations, the evaluator also has a sugar/unsugar module that transforms one or more constructs in the graphical representation of the computational diagram that are not able to be evaluated directly, but instead must be transformed into one or more structures that can be evaluated directly.

In some implementations, the system/user-interface enables the user at the computer device to provide a graphical element (e.g., half-circles at the input(s) and/or outputs, or other graphical indicators) to designate one or more of the blocks as having mapping functionality, such that, given a list of items (as opposed to a single item) as an input to the block and a particular function associated with the block, mapping the function over the input list yields an output list (as opposed to a single output) in which each element represents the result of the function applied to a corresponding one of the items of the input list.

In some implementations, the system is configured to identify (e.g., automatically), at the computer screen, any errors in the computational sequence, or graphical representation of the computational sequence. For example, if a user has drawn only two blocks connected the input of one block to the input of another block with a connective line, the system may automatically flag that as an error to the user. The system may do this in any number of possible ways, including, for example, by displaying an error message, or graphically marking the incorrect connection (with color and/or by bolding), etc.

In some implementations, the system/user interface enables the user at the computer device to zoom in to or out of the graphical representation of the computational sequence on the computer screen. In a typical implementation, zooming in may reveal more detail about each block (e.g., revealing a name for the box, showing its children, etc.), whereas zooming out may provide fewer details about the specific boxes, but may provide an overall view of the entire graphical representation, making it easier to understand the associated computational sequence (e.g., program).

In some implementations, the system/user interface enables the user at the computer device to enter text-based software code, representing a coded functionality, directly into one or more of the blocks. In those instances, any blocks that receive such text-based software code, would represent the coded functionality.

In some implementations, the system/user interface provides a transform-to-code functionality for one or more of the blocks in the graphical representation of the computational sequence. In some implementations, the transform-to-code functionality is accessible by a user clicking on, or otherwise selecting, some graphic element on one of the blocks at the user interface. The user's selection of the transform-to-code functionality causes the system to produce software code (i.e., text-based software code) based on the computational sequence represented in the one or more blocks.

In some implementations, the user interface and the evaluator are coupled together at a single physical location. For example the user interface and the evaluator may be together in a laptop, or at one person's computer workstation (e.g., computer/screen/keyboard/mouse), or on a server at a company where the user interface is available at one or more people's computer workstations, on a mobile device (e.g., smartphone or the like), etc. Software to facilitate the associated functionalities can be downloaded, in some instances, as a software application (e.g., an app).

In some implementations, the user interface is implemented at a first location (e.g., a user's workstation), and the evaluator is implemented at a second location (e.g., at a remote server) that is different than the first location. In those implementations, the user interface and the evaluator may be coupled to one another via a communications network (e.g., the Internet).

In a typical implementation, the computer-based system also includes computer-based memory storage (e.g., a local disk, and/or remote database, etc.) coupled to the user interface and the evaluator. The computer-based memory storage may be configured to store the graphical representation of the computational sequence and any of the one or more results from the computational sequence.

The blocks can have a variety of different associated functionalities including, for example, performing one or more mathematical operations, acting as a source of data, presenting a particular one or more of the results from the computational sequence, etc.

In another aspect, a computer-based method includes enabling a user, with a computer-based interface at a computer device, to: draw a plurality of blocks on a screen of the computer device, each block having an associated functionality; and draw one or more lines to selectively connect the blocks together thereby creating a graphical representation of a computational sequence on the computer screen, wherein the lines determine an order for performing the functionalities associated with the blocks. The computer-based method further includes evaluating (e.g., with a computer-based evaluator processor), the graphical representation of the computational sequence so that one or more results from the computational sequence can be returned to the computer-based user interface for display on the computer screen. The computer-based method further includes visually displaying each respective one of the results from the computational sequence at the user interface on the computer screen, in association with a corresponding one of the blocks.

In yet another aspect, a non-transitory machine-readable storage medium (e.g., a computer disk, or other computer-based memory storage device) stores instructions which, when executed, cause a computer-based processing device to display, at a computer screen of a computer device, a computer-based user interface that enables a user at the computer device to: draw a plurality of blocks on a screen of the computer device, each block having an associated functionality; and draw one or more lines to selectively connect the blocks together thereby creating a graphical representation of a computational sequence on the computer screen, wherein the lines determine an order for performing the functionalities associated with the blocks. The instructions provide for the processor evaluating the graphical representation of the computational sequence so that one or more results from the computational sequence can be returned to the computer-based user interface for display on the computer screen. The instructions further provide for the user interface visually displaying each respective one of the results from the computational sequence on the computer screen and in association with a corresponding one of the blocks.

In some implementations, one or more of the following advantages are present.

For example, in a typical implementation, the computer-based system and method(s) disclosed herein provide for specifying computational sequence(s) and desired result(s) in an intuitive, easy-to-use, graphical/visual form, rather than in a purely text-based (or computer code) form. Moreover, in a typical implementation, the desired results of the computation(s) are viewable in the same visual interface where the graphical/visual representation of the computational sequence(s) appears, and in the graphical representation. In a typical implementation, the computer-based system and method(s) disclosed herein provide that: 1) a program is specified graphically/visually (for example, by drawing a computational diagram), 2) functionality can be encapsulated and/or nested to any level, and 3) the outputs of the program are integrated directly into the specification of the program.

Other features and advantages will be apparent from the description and drawings, and from the claims.

### BRIEF DESCRIPTION OF THE DRAWINGS

FIG. 1 is a schematic representation of an exemplary computer-based visual programming system.

FIG. 2 is an exemplary graphical representation of a computational diagram that a user can create by drawing and connecting blocks at the user interface of the computer-based visual programming system of FIG. 1.

FIG. 3 is an exemplary implementation of user interface of FIG. 1.

FIG. 4 shows three exemplary graphical representations of a computational sequence that includes the PrimeQ function, which takes one number as an input and returns true or false depending on whether the input number is prime.

FIG. 5 is an exemplary graphical representation of a computational sequence that includes a raw block that enables a user to specify, and customize, functionality for the raw block by entering software code directly into the raw block.

FIG. 6 is an exemplary graphical representation of a computational sequence that includes composite blocks.

FIG. 7 is an exemplary graphical representation of a computational sequence with a “transform to code” button for one of the blocks.

FIG. 8 is a flowchart of exemplary processes for evaluating a graphical representation of a computational sequence.

FIG. 9 shows an exemplary “as drawn” version of a graphical representation of a computational sequence, and an “unsugared” version of the graphical representation.

FIG. 10 shows another exemplary “as drawn” version of a graphical representation of a computational sequence, and an “unsugared” version of the graphical representation.

FIG. 11 shows yet another exemplary “as drawn” version of a graphical representation of a computational sequence, and an “unsugared” version of the graphical representation.

FIG. 12 is an exemplary graphical representation of a computational diagram that, in which child blocks of a composite block are given a unique identifier within its parent.

FIG. 13 is an exemplary graphical representation where the system has identified an error in the associated computation.

Like reference characters refer to like elements.

### DETAILED DESCRIPTION

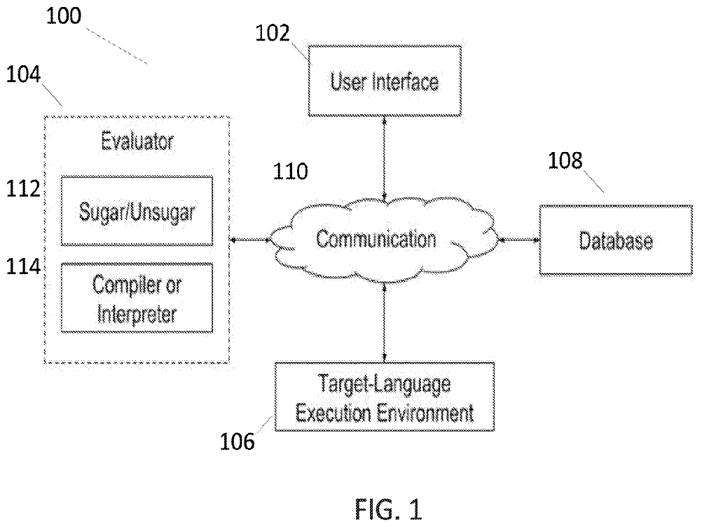

FIG. 1 is a schematic representation of a computer-based visual programming system 100 that is configured to perform and/or enable the various functionalities disclosed herein.

In general, the illustrated system 100 in configured to enable a user to create a graphical representation of a sequence of computational steps and data sources utilized by the computational steps, on a computer screen of a user interface device. In a typical implementation, the user can create the graphical representation directly in graphical form, that is, without having to write instructions in a text-based computer-code, or other complex, less user-friendly format first.

In a typical implementation, each respective computational step and data source can be represented by a discrete graphical element (e.g., a shape or other graphical symbol) in graphical representation, and logical relationships between the computational steps and data sources can be represented by lines (or other graphical indicators) between the discrete graphical elements on the graphical representation.

In a typical implementation, multiple graphical elements can be organized (e.g., nested or encapsulated) into groups to effectively create new graphical elements (that represent combinations of the nested or encapsulated computational steps or data sources). Typically, the encapsulation or nesting can be done to any degree, enabling the user to specify, through the graphical representation, highly complex calculations, if desired.

The system 100 typically enables a user to zoom in or out of the graphical representation. In various implementations, when the user zooms into a particular area of the graphical representation, the system 100 may reveal details that are otherwise hidden when the user has not zoomed in. Conversely, in various implementations, when the user zooms out (e.g., to view the entire graphical representation), the overall structure of the associated computation(s) may be revealed in a manner that is otherwise not visible when zoomed in to a particular area.

The system 100 performs any computational steps indicated by the graphical representation. This can be done automatically (e.g., without user prompting, as portions of a graphical representation are created and/or modified) and/or in response to a user's prompting (e.g., a user entering into the computer some kind of calculate command).

In a typical implementation, the system 100 causes the results of the computational steps to visually appear with the graphical representation on the computer screen of the user interface device. These results can include one or more end results of the overall sequence of computational steps, as well as one or more intermediate results within the overall sequence of computational steps. In some implementations, each result may be displayed (and appear) on the computer screen inside a corresponding one of the graphical elements on the computer screen. In some implementations, one or more of the results may be displayed (and appear) on the computer screen adjacent to (or otherwise visually associated with) a corresponding one of the graphical elements on the computer screen.

The illustrated system 100 has a computer-based user interface 102, a computer-based evaluator 104, an (optional) target-language execution environment 106, and an (optional) computer-based database 108. The system 100 components coupled to one another and able to communicate with one another over a communications network 110 (e.g., the Internet). The evaluator 104, in the illustrated system 100, has a sugar/unsugar module 112, and a compiler or interpreter 114.

Broadly, the computational diagram (i.e., the graphical representation of the computational step(s) and/or data sources) can be created and edited, by the user, at the user interface 102. The computational diagram can be stored in the database 108, which is usually only needed if the user interface 102 is delivered as a web service. The computational diagram can be evaluated by the evaluator 104. Results calculated by the evaluator 104 are sent to the user interface 102 where they can be and are, displayed to the user. The evaluator 104 is capable of evaluating the computational diagram and returning results based on the computational diagram that the user has indicated.

In various implementations, the evaluator 104 can include a compiler or an interpreter (at 114).

A compiler, in general terms, can be implemented by a computer-based processor executing computer software to transform computer code written in one programming language (a source language) into another programming language (a target language). In implementations where the evaluator 104 has a compiler, the computational diagram (the source language) may be compiled to a text-based code in a language (i.e., the target language, e.g., Mathematica, Python, Fortran, or even assembly code) that can be easily executed by a computer-based processor, and then executed by the computer-based processor, which may be part of the target-language execution environment 106, for example.

In a typical implementation, the target-language execution environment, if present, can include one or more computer-based processors and associated memory storage configured to execute functionalities according to the compiler's target language.

An interpreter, in general terms, can be implemented by a computer-based processor executing computer software to directly execute, i.e. perform, instructions written in a first language, without requiring them previously to have been compiled into a machine language program. In an exemplary implementation, the interpreter may use one of the following strategies to execute the steps represented in computational diagram: parsing the computational diagram and perform its indicated behaviors (i.e., computational steps) directly, translating the computational diagram into some efficient intermediate representation and executing that directly; or explicitly executing stored precompiled code (e.g., made by a compiler, which may be part of the interpreter as well).

Either of these evaluation approaches (i.e., a compiler or interpreter) can be used and the choice of evaluation strategy does not generally impact any other components of the system.

The sugar/unsugar module 112 represents computer-code that is executed on a computer-processor to handle sugaring and unsugaring functionalities in the system 100. “Sugar” in this context refers to constructs that are available to the user in the computational diagram that are not able to be evaluated directly, but instead must first be transformed into structures that can be evaluated directly. It is similar to syntactic sugar in text-based programming languages. These transformations generally happen without the user's knowledge, do not change the functionality of the computational diagram in any way, and are always reversed before results are shown to the user.

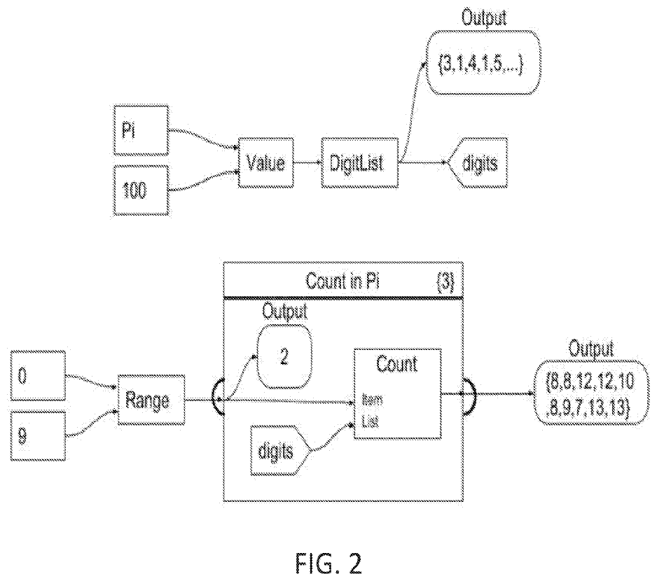

The user interface 102 in the illustrated implementation enables the user to create and edit a computational diagram, an example of which is shown in FIG. 2. The exemplary computational diagram causes the system 100 to calculate the first hundred digits of pi (π) and count how many times each digit (0 through 9) occurs in those first hundred digits of pi (π). More particularly, a first portion of the computational diagram causes the system 100 to calculate the first hundred digits of pi (π)—producing an intermediate result or “output” of {3, 1, 4, 1, 5, . . . }. A second portion of the computational diagram causes the system 100 to count how many times each digit (0 through 9) occurs in those first hundred digits of pi (π)—producing the final result or “output” {8, 8, 12, 12, 10, 8, 9, 7, 13, 13}. The computational steps represented in the computational diagram in FIG. 2 already have been executed by the system 100, as evidenced by the already present results, which appear in the two graphical elements that are labeled “output.”

It is important to note that, except for the entries in the various “output” elements, the exemplary computational diagram in FIG. 2 is exactly what the user would create and see at the computer screen of the user interface 102 before the system executed the computational steps to produce the indicated results, or “outputs.” As shown, the computational diagram includes a variety of graphical elements that represent computational steps (some of which are combined to produce a new function, e.g., the “Count in Pi” function) and data sources.

For example, in the computational diagram of FIG. 2, the graphical element (or rectangle) labeled “Pi” is a data source that includes the number Pi (π), the graphical element (or rectangle) labeled “100” is a data source that includes the number 100, the graphical element (or rectangle) labeled “Value” is a computational step that takes the inputs (Pi (π) and 100) and identifies the first 100 digits of Pi (π), the graphical element (or rectangle) labeled “DigitList” takes its input (i.e., the first 100 digits of Pi (π)) and produces a list of the first 100 digits of Pi (π), which appears in the graphical element (or rounded rectangle), labeled “output” as the list {3, 1, 4, 1, 5, . . . }. This list is fed into the graphical element (or flag) labeled “digits,” which is fed into the corresponding “digits” flag inside the “Count in Pi” graphical element.

Other specific aspects of the computational diagram of FIG. 2 are described below in detail.

In a typical implementation, the user can create computational diagrams, such as the one in FIG. 2, by creating each of the discrete graphical elements on a work area of the computer screen of the user interface, (optionally) combining some of the discrete graphical elements, and by connecting those discrete graphical elements with lines that create sequential and relational associations between the discrete graphical elements (and their associated functionalities or data).

The discrete graphical elements can be created by the user in any one of a variety of possible ways. For example, in some implementations, the system 100 maintains a library of pre-established graphical elements, from which the user can click and drag into a work space (on the computer screen) where the executable computational diagram is to be produced. In some implementations, the system 100 enables the user to create new graphical elements and specify (e.g., by entering text at the user interface) functionalities or data/data sources associated with each of the newly-created graphical elements.

The connective lines can be created by the user in any one of a variety of possible ways, too. For example, in some implementations, the user may create a connective line by manipulate a computer mouse to draw the connective line from one graphical element to another.

By creating a computational diagram, like the one shown in FIG. 2, and specifying (e.g., with “output” graphical elements, as shown) which of the calculated values the system 100 should display, the user can not only have the system 100 perform the desired calculations and receive the results of those calculations, but can also see any intermediate result(s), along the indicated computational sequence. In a typical implementation, the user can create and edit the computational diagram, and access the various functionalities disclosed herein, in a highly intuitive, user-friendly environment.

In some implementations, the computational diagram is stored in the database 108. This storing may happen automatically (e.g., as the computational diagram is created), or in response to a user prompt—for the computer system 100 to save the computational diagram. In some implementations, the system 100 does not store the computational diagram in a separate database (like database 108), but merely stores the computational diagram in a computer-based memory that is local to the user interface (e.g., a local disk or the like).

The system 100 can evaluate the computational diagram, with the evaluator 104, in any one of a variety of different ways. In one exemplary implementation, the system 100 evaluates the computational diagram, in response to a user prompt or not, by reading the computational diagram (e.g., from the database 108 or from the local disk associated with the user interface 102), evaluating the computational diagram with the compiler or interpreter 114, producing the desired result(s) with a computer-based processor, and recording the desired result(s) (e.g., in the database or local disk). The system 100 then produces the desired results at the graphical representation on the computer screen of the user interface, as shown for example in FIG. 2, for display to the user.

The communication bubble in the middle of FIG. 1 can be the internet or any other computer network, inter-process communication on a single computer, in-memory communication in a single process, or any other medium over which components of applications or computer components can communicate. In implementations where the user interface 102 is being delivered over the internet, all other components would generally run on external infrastructure such as one or more servers run by a company.

All of the components shown in FIG. 1 are not always provided. If the user interface 102 is run directly on a user's computer, for example, instead of being delivered over the Internet and displayed in a web browser, then the database 108 may not be provided. Similarly, the target-language execution environment may be provided only if the evaluator 104 uses a compiler. If the evaluator 104 instead uses an interpreter, there is no target language and there is no need for a separate target-language execution environment as the interpreter evaluates the computational diagram directly.

In one exemplary implementation, the user interface (that appears at a user computer, for example) could be written in JavaScript (or a similar language) and delivered in a web browser. In those implementations, the system 100 might prompt or enable the user to create an account with an online service and the user's computational diagram(s) would be stored by the system 100 in a database (e.g., 108). When the user wants to evaluate a particular one of the stored computational diagrams, the evaluator 104 (running, for example, on back-end infrastructure) might access the stored computational diagram from the database 108, unsugar it, send it to the interpreter 114 (also running on back-end infrastructure, for example) for evaluation, resugar the results, and return them to the browser—for viewing at the user interface together with a visual/graphical representation of the computational diagram. Alternatively, instead of using an interpreter, the evaluator 104 could send the diagram to a compiler, run the resulting code in the target-language execution environment 106 (either on the same infrastructure or perhaps a proprietary third-party environment), and return the results to the browser—for viewing at the user interface together with a visual/graphical representation of the computational diagram.

In some implementations, all of the components represented in FIG. 1 could run locally on a user's computer (except, for example, the database 108, which may not be required). This may allow faster access to data inputs, improved data privacy, lower latency, a different cost model, and different computational resources.

In some implementations, all of the components represented in FIG. 1, except for the database 108, could be included as add-ons to a pre-existing mathematical computational environment which normally uses text-based code. In this case, the user interface (UI) 102 of FIG. 1 may be provided as an additional graphical interface to the pre-existing software. The compiler, if provided in those instances, might compile the computational diagram to code in the language of the pre-existing environment, and the target-language execution environment 106 might simply be the pre-existing environment.

### Usage Example

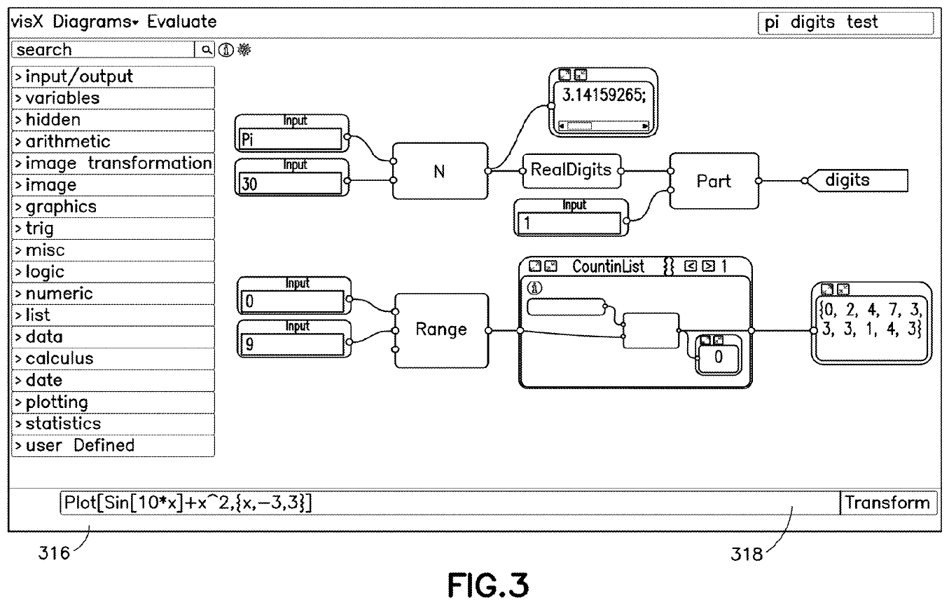

Before going into detail, here is an example of how a user might use the system 100 to specify and execute computations. Referring again to FIG. 2, the illustrated computational diagram would cause the system 100 to calculate the first 100 digits of the numerical constant Pi, and count how many occurrences of each digit (0 through 9) there are. FIG. 2 is a conceptual example of the user interface, and FIG. 3 shows an actual exemplary implementation (with a similar computational diagram). One of the purposes of the user interface 102 component of FIG. 1 is to display a computational diagram like that shown in FIG. 2 on a computer screen at a user device, to allow the user to manipulate the computational diagram, and to present the calculated results.

The user interface 102 displayed to the user is composed mainly of blocks and links. All of the rectangles, rounded rectangles, and 5-sided shapes (e.g., flags, like those labeled “digits”) may be referred to herein as blocks. Links are the arrows or lines connecting the blocks. Each block, in the illustrated examples, takes its input(s) on its left and transforms them to outputs on its right. The block labeled “Value,” for example, produces a decimal expansion of its first input (Pi) with the number of digits to be calculated specified in the second input (100). In this case, it calculates pi to 100 digits. “DigitList” takes a number as input and returns a list of the digits in that number. So, if the number 123 were given as input, the output of DigitList would be the list “{1,2,3}”. In the example shown in FIG. 2, DigitList outputs a list of the first 100 digits in Pi. The numerical value of Pi is 3.1415 . . . , so the output of DigitList is the list “{3,1,4,1,5, . . . }”. In fact, this value is shown in the Output block at the top of the figure.

The top row of blocks calculates the decimal expansion of pi and stores it in a block called “digits.” The bottom row of blocks begins by taking each number from zero to nine (the output of the “Range” block), then finds how often that digit occurred in the previously calculated decimal expansion. The output block in the lower right shows that, for example, there are 8 zeros, 8 ones, and 12 twos in the first 100 digits of pi.

The “Count in Pi” block, when viewed in isolation, takes one number as an input and calculates how many times that number occurs in “digits.” If “0” were the only input to the “Count in Pi” block, the output would be “8” because there are 8 zeros in “digits.” In the diagram above, though, “Count in Pi” is used in a map structure indicated by the semi-circles surrounding the input and output areas, described in detail below. This causes the block to operate not on its input, but rather on each element of the input list, in this case applying “Count in Pi” to each number from 0 to 9.

Also note the output block inside “Count in Pi.” Normally, output blocks simply display the value that they receive. In this case though, the “Count in Pi” block is executed 10 times (once for each of the digits in 0 to 9), so which value should be displayed? With blocks used in map structures, like this one, the user can choose which iteration to use for displaying child outputs. The “{3}” in the upper right corner of the “Count in Pi” block indicates that the user has chosen to see the third iteration, so the child output displays “2” because that is the third number in the input sequence of “{0,1,2,3,4,5,6,7,8,9}”. If the user changed the “{3}” to “{1}”, the child output would change from “2” to “0”.

### User Interface

The user interface (e.g., 102 in FIG. 1) is a system for expressing (and showing on a computer screen of a computer device) computational sequences and desired results (which may be referred to as a “computer program”) as a computational diagram. The computational diagram consists mainly of blocks of functionality, links that connect them, result indicators, and specifiers for maps and other control (or data) structures found in some programming languages. The user interface enables users to draw and manipulate these diagrams, and to obtain the requested results.

### Blocks

In a typical implementation, every piece of functionality associated with a particular computational sequence is encapsulated into a block (that appears in a graphical representation of the computational sequence at the user interface 102).

Each block has zero or more inputs and zero or more outputs. The blocks transform inputs into outputs according to their respective functionalities. For example, one block might take two inputs, one being an image and the second being a brighten factor, and output a version of the image brightened by the brighten factor. Every procedure in the system, from a simple numerical addition to a complex facial recognition algorithm or DNA sequencing procedure, is done inside a block. Each rectangle in FIG. 2 is a block.

Data can be input into the program, for example, by using a block with zero inputs and one output. This input block could contain a text field in which a user enters a number, for example, or it could contain a data file uploaded by the user. In FIG. 2, the “Pi” and “100” blocks are examples of input blocks.

Blocks can be divided into two different types: composite and non-composite. Composite blocks are composed of other blocks, while non-composite blocks are not. For example, the “Count in Pi” block in FIG. 2 is a composite block, while the DigitList block is not.

Relationships between blocks can sometimes be referred to using ancestral terminology, such as parent, child, and sibling. In FIG. 2 for example, the block labeled “Pi” and the block labeled “Range” may be considered siblings because they are sub-blocks of the same parent block, which in this case is the top level diagram. The block labeled “Count” may be considered a child of “Count in Pi” because the “Count” block is part of the “Count in Pi” block. As a result of the meanings of child, parent, and composite blocks, it is noted that the term parent block is the same as the term composite block because a composite block is composed of other blocks, while a parent block is also composed of other blocks (child blocks).

Blocks can be nested to create complex functionality. A composite block would have its own inputs and outputs, and the way it transforms those inputs into outputs is specified by its child blocks and links. Composite blocks can be nested to any level, and used together with non-composite blocks without restriction. The lowest level blocks are non-composite blocks (“Plus,” for example, which adds its inputs) and are evaluated directly by the evaluator 104. They have no child blocks themselves.

Any third-party code or external software package can be integrated into the system 100 as yet another block. Typically, these third-party blocks do not have any children blocks. Instead, in a typical implementation, the third-party blocks take their input values and send them to the third party software package, run that third party software package, and collect the results, then return those results through the output(s) of the third-party block.

Links Blocks can be connected by linking the output of one block to the input of another block. The arrangement of blocks and links specifies how data should flow through the program.

In a typical implementation, the user interface 102 may contain one or more checks to make sure that links are created in a sensible way. In general, the system 100 rejects links from the input of one block to the input of another block, for example.

In addition to simply connecting output to input, links provide a convenient way for the evaluator to find and optimize reused results. If, for example, more than one link comes out of an output, the system 100 knows that that value is used more than once so it can store the result for future re-use instead of re-computing it multiple times. In some implementations, the system 100 is configured to do just that—identify any outputs from which multiple links extend, and store the results produced at those outputs in a computer-based memory storage, identify when the same result (or output) may be needed again elsewhere (e.g., at the tail end of another link coming off the same output), and providing the stored result from the computer-based memory storage instead of having the system 100 recalculate.

### Outputs

The user can indicate that an output is requested by placing an output block, which has one input and zero outputs. In a typical implementation, the presence of such a block (i.e., one with one input and zero outputs) indicates that the user wishes to view a result. The user indicates which result the output should display by connecting a link from that result to the input of the output block. When the system 100 evaluates the computational diagram, the system 100 places an appropriate result into the output block and shows it in the computational diagram at the user interface 102. In FIG. 2, for example, the rounded rectangles are output blocks.

Conveniently, in a typical implementation, an output block can be placed at any level or position in a computational diagram (e.g., at the top level or inside any nested block at any level). This makes it easy for the user to view intermediate results of a computation as well as final results. Viewing intermediate results with such ease can be a useful tool (e.g., for checking a computational diagram, especially a complex data analysis diagram). The output block that includes “{3,1,4,1,5, . . . }” in FIG. 2 shows an intermediate result, and the output block inside the “Count in Pi” block shows an intermediate result inside a nested composite block.

A large number of data types can be shown inside output blocks. Some of these data types can be numbers, some are lists, others are matrices, images, plots, etc. Output blocks can show any type or any combination of types of data.

Moreover, in a typical implementation, the system 100 enables users to download the data shown in an output block to their own computers for further analysis or storage if desired.

### Functional Map

The phrase, “map” refers to an operation in functional programming. Given a list of items and a function, mapping the function over the list yields a list in which each element represents the result of the function applied to the corresponding element of the input list. For example, mapping “Double” over a list “{1,2,3}” would yield “{2,4,6}.” Mapping is a common way to apply a function to a large amount of data in a functional programming system. In some implementations, the system disclosed herein enables the user to specify a mapped function using visual, graphical (i.e., non-textual) form. There are a variety of ways that this can be accomplished. In one exemplary implementation, the system 100 does this by enabling the user to draw a map indicator around the inputs and outputs of a block that the user wants to specify should be mapped over. In FIG. 2, the semi-circles around the input and output ports of the “Count in Pi” block are the visual indications of a map operation.

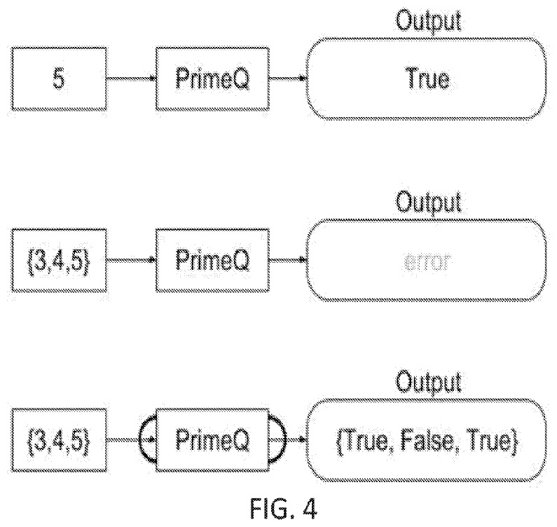

FIG. 4 is useful to explain an exemplary map operation. The example in FIG. 4 uses a PrimeQ block, which takes one number as an input and returns true or false depending on whether the input number is prime. The top diagram in the figure shows that the number five is prime.

In that top diagram, the input to the PrimeQ block is a single number, five, and the output of the PrimeQ block is true. The PrimeQ block in the top diagram of FIG. 4 is not a map function (e.g., it does not have semi-circles at its input and output); it is only suited to processing a single input —like the number five—at a given time. If a list is provided to the input of the PrimeQ block, as shown in the middle diagram, an error will result because PrimeQ takes a number as an input, not a list. Primeness is not a mathematical property commonly defined for lists, so an error is output. In the lower diagram, PrimeQ is mapped over the list instead. This mapping ability is evident from the semi-circles that appear at the input and output of the PrimeQ block in the lower diagram. This causes PrimeQ to operate not on the list, but on each respective element of the list. Each respective element of the list is produces one output of PrimeQ given that element as an input. Three is prime, four is not, and five is, so this map operation returns the list “{True, False, True}”.

Mapping, like any other operation, can be done at any level of nesting in the diagram. In a typical implementation, the system 100 even enables users to draw one map block inside another map block.

In a typical implementation, any block can be mapped over. If a composite block is mapped over, the system 100 enables the user to place an output block inside that composite block. In that case, the system 100 may decide which result to display inside the output block. The user interface allows the user to specify which iteration through the map should be used for selecting the result.

In various implementations, the system 100 provides for one or more other functional programming constructs, including, for example, folding, Currying, recursion, etc.

### Errors

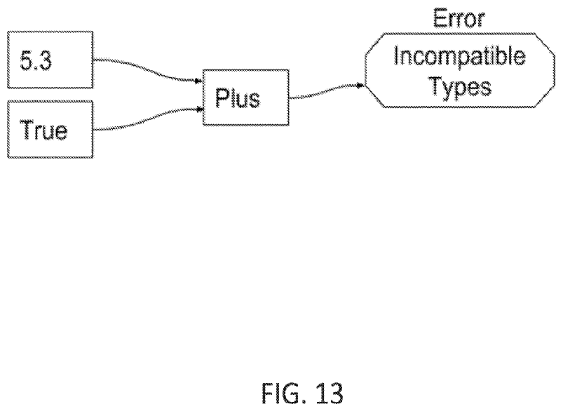

In attempting to execute a computer program (e.g., computational sequence based on a user-created graphical representation of the computational sequence), the system 100 may identify one or more errors. In some implementations, the system 100 is configured to display these errors to the user along with information about how and where they were generated. In one exemplary implementation, the diagram enables this type of feedback intuitively, by simply highlighting, or otherwise visually marking, the affected block or blocks, and if appropriate the port, in which the error occurred. This facilitates error identification and correction to the user. See, for example, FIG. 13, which shows what this, in one implementation, would look like. FIG. 13, in this regard, shows an example of a box with an error, and the system has identified the box as such.

### Zooming

A computational diagram can potentially be complex and contain many levels of functionality. In some cases, it would be overwhelming to show every block in the diagram on the screen at the same time. Instead, in some implementations, the system 100 is configured so that the interface to the diagram adapts dynamically, showing only as much detail as can reasonably be shown on screen. If the user wishes to see more detail in a particular area of the diagram, he or she can zoom into that area and the system 100 will automatically show more detail.

There are several types of information that could be shown inside a block, including its name, ports, port labels, and children (and information inside the children, etc.). In various implementations, depending on the current zoom level, the system 100 may display, at the user interface 102, none, some, or all of the information for a particular block (or blocks). For example, if there is not enough room inside a block at the current zoom level to display any information to the user, the block will be drawn as an empty rectangle. As the user zooms in and more space becomes available inside the block, the system will draw the name of the block. With greater and greater zoom, the system 100 will draw progressively more information. Finally, when enough space is available, the children of the block can be drawn. They may be drawn as empty rectangles at first, but with yet more zooming, the children will show more information, and so on with their children, etc.

In some implementations, this feature nicely solves one of the problems with large text-based software systems, which is that all of the code is generally shown at once all the time and it is difficult to get a high-level overview of what the software does. With this user interface 102, in contrast, one need only zoom out. The system 100 will remove more and more detail as higher and higher level blocks come into view until the user can view the diagram at the desired level. To probe the details of a part of the diagram more deeply, the user simply zooms in to that part.

In conventional software engineering, the code of a function may be written once but the function is used in multiple places by referencing its name. In those instances, if a programmer encounters a place where a function is used but wishes to know how the function is implemented, he or she usually must go find the code for the function. In a typical implementation of the system 100 disclosed herein, however, if a block is used in multiple places, it may appear in the graphical representation in multiple places, or be linked to in the graphical representation from multiple places, and the user can see and edit the contents of the block wherever it is used by simply zooming into it. This makes it easy to quickly see the contents of the block, edit them if desired, then zoom back out to the higher-level position.

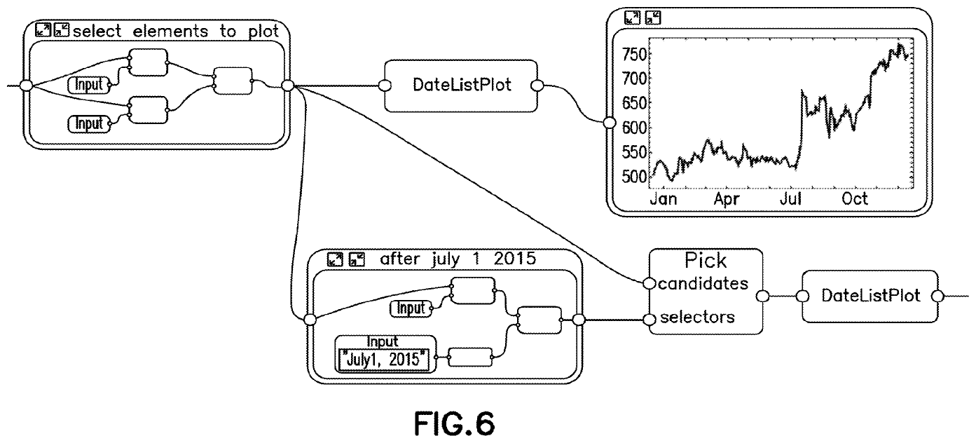

FIG. 6 provides an exemplary implementation of the user interface showing blocks contained in other blocks. In a typical implementation, the user could zoom into either of these blocks and see their contents rendered as more blocks.

### Conventional Text-Based Code

Blocks and arrows (or connecting lines) are often a convenient way to specify a computation, but they are not always the best way. Sometimes a user may wish to work with conventional text-based code. In various implementations, the system 100, through its user interface 102, enables users to work with conventional text-based code. There are several ways that the system 100 may enable this functionality.

In some exemplary implementations, the system 100 enables the user to enter code directly into a block, in which case the block might be called a “raw” block. Raw blocks are not composed of other blocks but instead their operation (or function) is specified by code that is typed directly into them. When a raw block is evaluated, the system 100 may run the code inside the block directly.

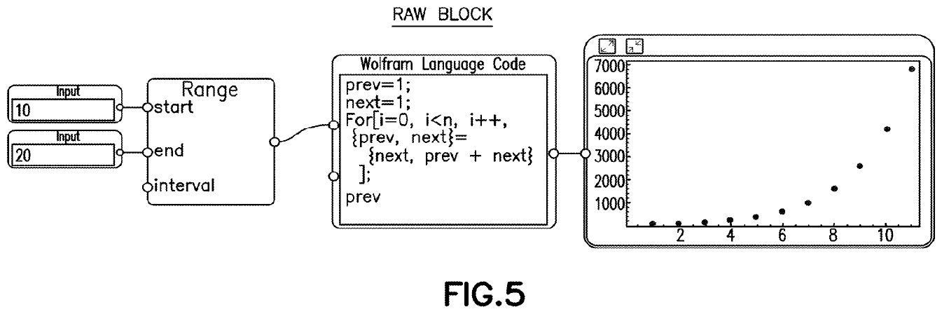

The screenshot in FIG. 5 shows an exemplary graphical representation of a computational sequence that includes a raw block.

In some instances, the user may wish to input text-based code and ask the system 100 to transform that code into regular blocks which the user could then further edit or evaluate. In some implementations, the system 100 enables the user to do this sort of thing by providing a small text box on the user interface 102 where the user can enter text-based code and have the system 100 transform that text-based code into a block. An example of this is shown at the bottom of the screenshot in FIG. 3. More particularly, the screenshot in FIG. 3 has a text box 316 where the user can enter the text-based code, and a “transform” button 318 that the user can click to cause the system 100 to transform the text-based code into a block and place that block into the computational diagram. When the system 100 receives an indication that the user has clicked on, or selected, the “transform” button 318, the system 100 transforms the text-based code in text box 316 into a block and places the block into the computational diagram.

The particular method that is used to transform text-based code into blocks is dependent on the programming language that the text-based code is written in. Generally, for compiled languages, the text-based code would be sent to a compiler for that language but then intercepted at an intermediate stage of compilation which represents only the functional relationships between the statements in the text-based code. Once these functional relationships have been determined by a compiler specific to the language of the text-based code, they can be easily translated into the blocks and arrows of the present invention. This is not possible for all text-based languages. For interpreted languages, a similar procedure would be followed except instead of intercepting an intermediate stage of the compiler, the system would invoke the interpreter itself and intercept it at an intermediate stage. Finally, some programming languages and associated execution environments provide the capability to parse a piece of text-based code but then “hold” it in an unevaluated form which can then be examined. If this capability is present, it is generally the best way to transform code into blocks and arrows because the same execution environment that will eventually evaluate the diagram can be used for the transformation.

There is no requirement that the programming language of the text-based code entered by the user for transformation be the same language that the diagram itself is compiled to for eventual evaluation.

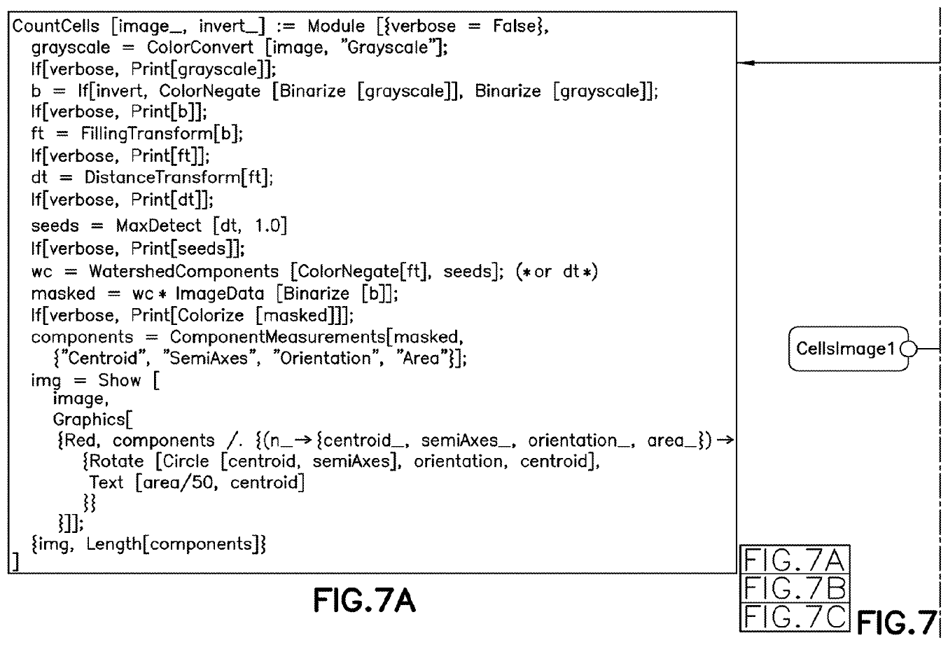

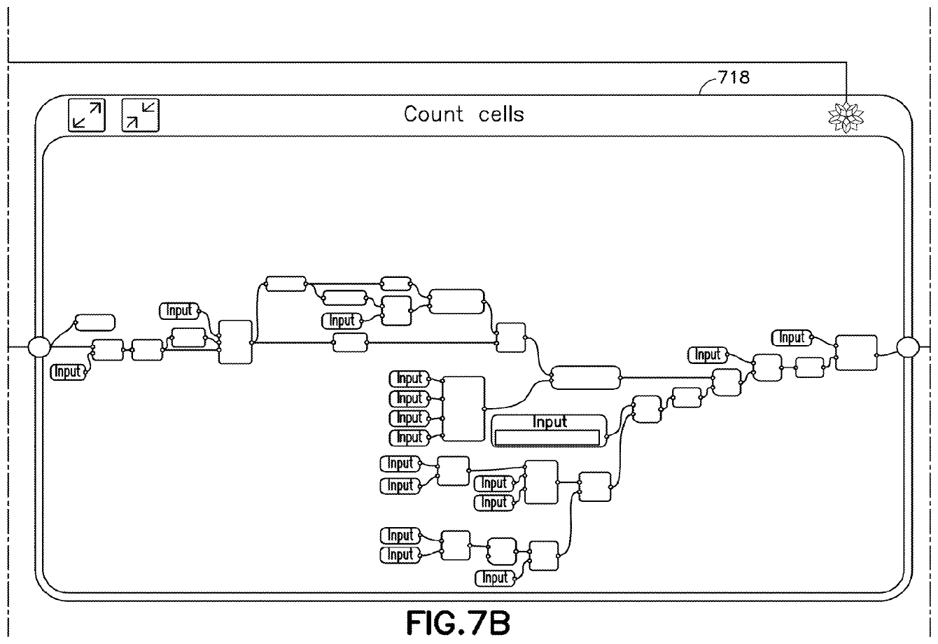

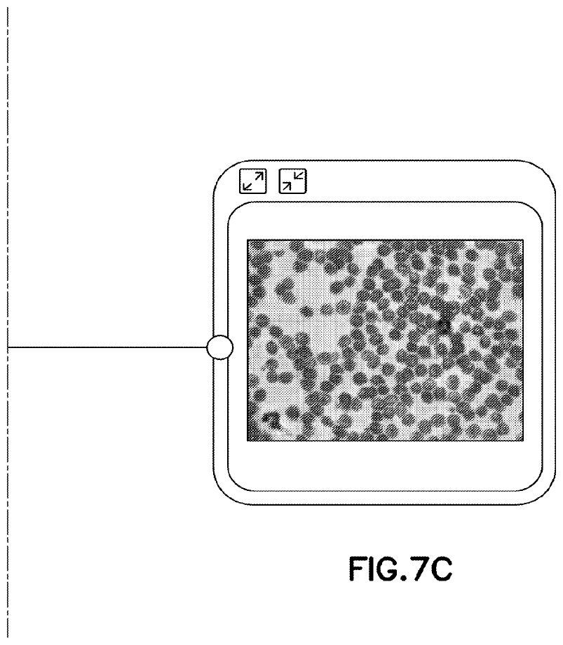

In some instances, the user may wish to transform one or more blocks, or the entire computational diagram, into text-based code. In some implementations, the system 100 is configured to facilitate this functionality. In some such exemplary implementations, the system 100 would not run the code, the system 100 would only compile the computational diagram (e.g., with the compiler at 114) and return the resulting code (or a simplified version thereof). In a typical implementation, this resulting code would have the same functional effect as the original block or blocks. To expose this feature, the system 100 provides, on its user interface 102, a “transform to code” button on one or more (or all) of the blocks, composite blocks, and/or the overall computational diagram itself. FIG. 7 shows an exemplary graphical representation of a computational sequence with a “transform to code” button 718 on (and for) the “count cells” block. As indicated in FIG. 7, if the system 100 notices that a user has clicked on or otherwise selected the “transform to code” button 718, the system raises a window, at the user interface 102, that contains the compiled code for that “count cells” block. To create this code, the system takes the indicated block, in this case the “count cells” block, and proceeds as if it were going to evaluate only that block. This requires compiling the block. If the user had requested evaluation of the whole diagram, that compiled code would be combined with other compiled code for other blocks and run. In this case, though, the code for that block is simply returned to the user, possibly after being somewhat simplified. In the example represented in FIG. 7, the user has drawn a computation inside the “count cells” block using other blocks, then transformed that calculation into text-based code.

### Rendering Procedure

Once one or more features (e.g., blocks and connective lines) of a computational diagram have been specified by a user (and, optionally stored in the system database 108), the system 100 can, through the user interface 102, draw the computational diagram on the computer screen of the user interface device. Moreover, the system 100 can alter the computational diagram in response to user commands (entered at the user interface device), adjust the drawn computational diagram accordingly, and save any changes back into the database 108. This section describes an exemplary procedure that the system 100, and its user interface 102, utilizes to render a computational diagram (i.e., a graphical representation of a computational sequence), and some of the ways that user actions can modify the computational diagram.

The exemplary rendering procedure, which is performed by the system 100, includes:
1. Clearing any prior computational diagrams.
2. Recursively executing the following procedure(s) for each block beginning with any top-level block(s).
   a. Determining how much space is available to draw the block. If the available space exceeds a maximum threshold, drawing the block with maximum detail. If the available space is less than the maximum threshold but greater than a medium threshold, drawing the block with medium details. Otherwise drawing the block with minimum detail.
      i. To draw a block with maximum detail, the system 100:
         1. Draws the border of the block.
         2. Draws the title of the block.
         3. Draws the input and output ports of the block.
         4. Recursively executes step two for each child block. Step two draws a block including its children, but the procedure to draw the children is the same as the procedure to draw the parent since both are blocks. Therefore, the parent causes the children to be drawn by simply invoking step two once for each child. If those children have grandchildren, then when the children reach step 2.a.i.4 of their own rendering procedure, it will cause them to again invoke step two for each grandchild, and so on.
         5. For any connected pair of output port and input port among the child blocks inside this block, draws a link.
         6. If this block is mapped over, draws the map indicators on the appropriate ports and the output iteration indicator in the upper right.
      ii. To draw a block with medium detail, the system 100:
         1. Draws the border of the block.
         2. Draws the title of the block.
         3. Draws the names on the input and output ports of the block, if any. These could be variable names like “x” or “y” or brief explanatory words or phrases like “aspect ratio” or “resolution”.
         4. Draws the input and output ports of the block.
      iii. To draw the block with minimum detail, the system 100:
         1. Draws the border of the block.
         2. If space allows, draws the title of the block.
3. The system 100 executes the following procedure for each output block that was drawn by step 2. Note that this may not be every output block in the whole diagram because some may be inside blocks which are not shown at their full detail level.
   a. Draws the border and title of the block.
   b. Draws the value inside the block.
4. The user interface 102, in various implementations, can provide many editing capabilities to the user, including but not limited to:
   a. Enabling the user to move a block by clicking and dragging.
   b. Enabling the user to select a block by clicking on its title (or elsewhere on or near the block).
   c. Enabling the user to draw a link from one block to another by clicking on (or near) the first block and dragging a new link to the other block.
   d. Enabling the user to change the encapsulation by dragging one block from its current parent, out of the parent and, optionally, into another parent.
   e. Enabling the user to place new blocks onto the diagram by clicking and dragging from a library of available, predefined blocks.

In a typical implementation, whenever the user takes an action that could change the diagram, such as any one or more of those listed above, the user interface 102 saves the new diagram into the database 108 and re-initiates the rendering procedure.

### Evaluator

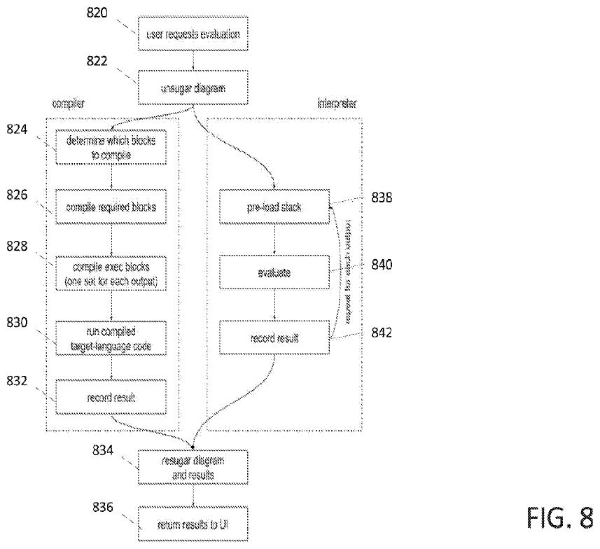

In some implementations, once the computational diagram has been created and the system 100 has drawn it at the user interface 102, if the user wants to see the output values, the system evaluates the computational diagram. There are two main ways this can be accomplished. Either the computational diagram can be compiled into text-based code in an existing computer language (the “target language”) and then evaluated (e.g., in the target-language execution environment 106), or the computational diagram can be interpreted directly by an interpreter. An evaluation flowchart, depicting both of these options, is shown in FIG. 8.

According to the illustrated flowchart, a user (at 820) requests the evaluation. This request can be made in any one of a variety of different ways. For example, in some implementations, the system 100 will display, at its user interface 102, an “evaluate” button, the selection of which triggers the rest of the steps shown in FIG. 8.

Next, in the illustrated flowchart, the system 100 (at 822) unsugars the computational diagram.

“Sugar” in this context refers to constructs that are available to the user in the computational diagram that are not able to be evaluated directly, but instead must first be transformed into structures that can be evaluated directly. It is similar to syntactic sugar in text-based programming languages. These transformations happen without the user's knowledge, do not change the functionality of the computational diagram in any way, and are generally reversed before results are shown to the user.

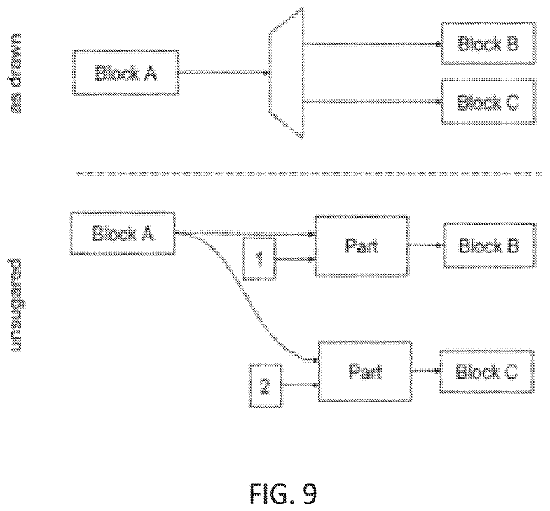

One exemplary type of sugar involves a list destructor block. A list destructor is a block available to the user which takes a single list as an input and outputs each element of the list as an individual output. Since most text-based programming languages do not permit a function to have more than one output, these list destructor blocks must be unsugared into explicit “Part” constructs. This type of sugar is described, and represented, in FIG. 9.

There are two schematic representations in FIG. 9, one of which is labeled “as drawn” and the other of which is labeled “unsugared.” The “as drawn” schematic shows what might appear at the user interface 102, after the user has specified the associated functionalities and the system 100 has drawn the indicated “as drawn” computational diagram at the user interface 102. The “unsugared” representation is a schematic representation of an unsugared version of the “as drawn” schematic representation. In this example, the “as drawn” schematic representation includes a list destructor block (which is the unlabeled trapezoidal block), which represents a construct that the system 100 is not able to evaluate directly. Instead, according to the illustrated example, the list destructor block in the “as drawn” representation is first transformed into structures (shown in the “unsugared” schematic representation) that the system 100 can evaluate directly, with evaluator 104.

Each “part” block shown in the “unsugared” portion of FIG. 9 takes a list (Block A) as its first input and an index (1 or 2) as its second input and outputs the element of the list corresponding to the index. The block with the number 1, instructs the associated “part” block to output the first position list item from Block A to Block B, while the block with the number 2 instructs the “part” block to output the second position list item from Block A to Block C. This is functionally equivalent to the “as drawn” computational diagram. So, in essence, from a functionality perspective, the “unsugared” schematic is the same as the “as drawn” schematic. The system 100 is unable to directly evaluate the “as drawn” schematic, for reasons set forth, but the system 100 is able to directly evaluate the functionally equivalent “unsugared” schematic (again, with evaluator 104).

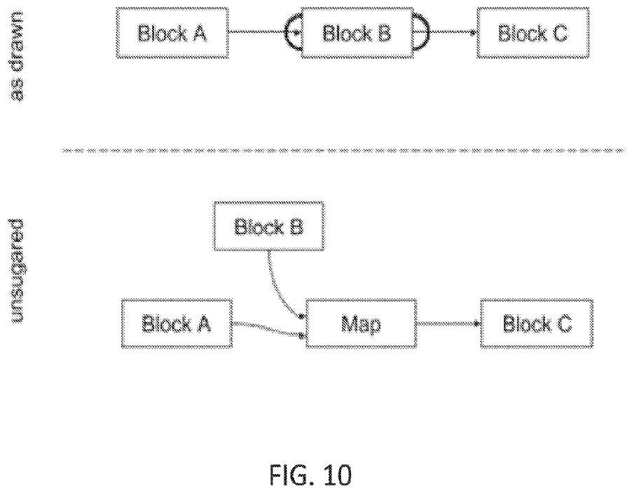

In a typical implementation, map indicators are also unsugared, since the visual indicator of a map operation in the computational diagram is specific to the diagram interface and does not have a direct analog in typical text-based programming languages. Therefore, in a typical implementation, map indicators are unsugared into explicit map operations as shown in FIG. 10.

FIG. 10 shows an “as drawn” and “unsugared” graphical representation of essentially functionally identical computational sequences. In a typical implementation, the system 100, as part of its evaluation, would transform the “as drawn” graphical representation, which cannot be directly evaluated by the evaluator 104, into the “unsugared” graphical representation. The “Map” block in the “unsugared” graphical representation takes a block as its first input and a list as its second input, and maps the block over the list. The arrow coming out of the bottom of Block B on the lower part of this figure indicates that the entire block rather than just its output is used as the first input to map.

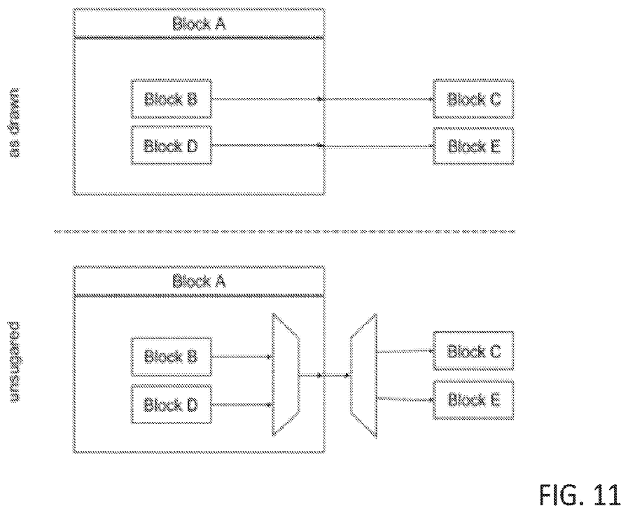

A third type of a use of sugar involves blocks with multiple outputs. Since most text-based programming languages do not permit functions to have multiple outputs, the system 100 may utilize sugar to allow this in the computational diagram. In an exemplary implementation, anytime a multi-output block is encountered, the system 100 modifies the computational diagram so that the outputs are instead placed into a list which is then output from the block. List destructor blocks are similarly placed on the output side. An example of this is shown in FIG. 11.

FIG. 11 shows an “as drawn” and “unsugared” graphical representation of essentially functionally identical computational sequences. In a typical implementation, the system 100, as part of its evaluation, would transform the “as drawn” graphical representation, which cannot be directly evaluated by the evaluator 104, into the “unsugared” graphical representation. The trapezoidal blocks in the “unsugared” graphical representation indicate list creation and destructor blocks.

### Compiler

At a high level, the purpose of the compiler is to take the computational diagram as written by the user and unsugared, and produce code in the target language which, when run (e.g., within the target-language execution environment 106), calculates the user's desired results (i.e., everything that has an output block connected to it). The system 100 then runs that target language code (e.g., in the target-language execution environment 106), collects the results, and returns those results to the front end (e.g., the user interface 102) for display to the user at a user interface device.

Any general-purpose programming language can be used as the target language. When the system and techniques disclosed herein are utilized for mathematical analysis, it may make sense to choose a target language well suited to that purpose, such as Mathematica, Python, Fortran, or even assembly code. When using the system and techniques disclosed herein for purposes such as web crawling, JavaScript may be a better choice for the target language.

### Preliminaries

Before going into detail on the compiler procedure(s), this section introduces and describes some preliminary concepts about the compiler.

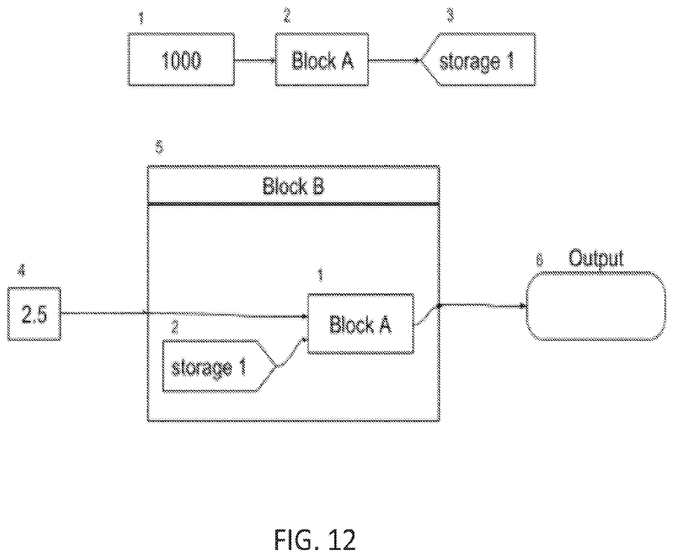

In some implementations, each child block of each composite block is given a unique identifier within its parent, called IdInParent. FIG. 12 shows an exemplary computational diagram that includes such unique (IdInParent) identifiers. In FIG. 12, the IdInParent of each block is shown above and to the left of each block. Ina typical implementation, the only requirement for the IdInParent is that it be unique within each parent block.

The system 100 typically needs a way to uniquely identify every block in the diagram. Since it is possible for a block to be used in more than one place, like “Block A” in FIG. 12, it cannot just use the name of the block nor the IdInParent. For this purpose, the system 100 introduces the concept of ancestry which is just the list of IdInParent of the block in question and all of its ancestors. For example, the ancestry of the “1000” block would be “{1}” and the ancestry of the “Block A” inside the “Block B” would be “{5, 1}”. In this way, every block everywhere in the diagram has a unique ancestry.

Additionally, the compiler may use a stack as a way of keeping track of the computation as it proceeds. Stacks are data structures used in computer science, and particularly in code execution. The system 100 (and techniques) disclosed herein uses a stack in a typical manner. In a typical implementation, the elements of each stack frame are: 1) block name, 2) IdInParent, 3) iteration number (when required for map constructs), and 4) storage values. The iteration number is used to keep track of how many times through a mapped or recursive invocation the evaluation has gone at a given stack frame. This is not always required because only some blocks are used with mapping or recursion. Since the value of the storages could change at different times during the computation, their values must also be included on the stack.

### Compiler Procedure

Referring again to the flowchart of FIG. 8, the first step in compiling the computational diagram (at 824) is for the compiler to determine which blocks need to be compiled, which is usually every composite block in the diagram. In a typical implementation, the system 100 uses a recursive algorithm, beginning with the diagram itself and finding each composite block at the top level, then each child of each of those, and so on all the way down until every composite block has been found. Each of these composite blocks is added to a list of blocks which need to be compiled. The list may be stored in computer-based memory. Exemplary pseudocode for this procedure is shown here.

```
set blocksToCompile to empty list
add mainDiagram to blocksToCompile
define function findChildrenOf(block):
  for each child in block:
    if child is composite:
      add child to blocksToCompile
      run findChildrenOf(child)
run findChildrenOf(mainDiagram)
```

Procedure 1: Exemplary pseudocode to find which blocks need to be compiled.
After running this code, blocksToCompile will contain a list of everything that must be compiled to execute the diagram.

The next step in the illustrated process (at 826) is for the compiler to actually compile each block that needs to be compiled. In a typical implementation, for each of these blocks, the compiler will output code in the target language which, when run (e.g., in the target-language execution environment 106), performs the same function that the block itself would perform. Procedure 2 shows exemplary pseudocode for this phase. The pseudocode on the left describes the actual compiler procedure, and the pseudocode on the right describes the target language code that the compiler outputs.

| step | compiler pseudocode | target language pseudocode |
|---|---|---|
| 1 | write the start of the function | define function BlockName(input1, input2, ...): |
| 2 | write the evaluation wrapper | define function doSubblock(id, expression): |
| | | if this result is in storedResults: |
| | | return value from storedResults |
| | | else: |
| | | run expression |
| | | store result in storedResults |
| | | return result |
| 3 | for each child: | |
| 4 | if child is storage lookup: | define subblock#idInParent = |
| | find this storageName | topFrame(storageName) |
| | look up value in topFrame | |
| 5 | if child is raw input: | define subblock#idInParent = (raw input) |
| | write raw input directly | |
| 6 | if child is normal block: | define subblock#idInParent = |
| | find blockName(such as | doSubblock(idInParent, blockName(arguments)) |
| | “BlockA”) | |
| | find input arguments (such | |
| | as arg1, subblock 2) | |
| | write calculation for this | |
| | block | |
| 7 | write code to push stack | set newTopFrame = StackFrame(ancestry, |
| | | idInParent) |
| | | push newTopFrame onto stack |
| 8 | for each setStorage: | |
| 9 | if storage is set by another | set topFrame(storageName) = subblock |
| | block: | #idInParent |
| | find idInParent of the block | |
| | feeding the storage | |
| | write code to set the | |
| | storage | |
| 10 | if storage is set directly by | set topFrame(storageName) = inputN |
| | an input: | |
| | find which input feeds the | |
| | storage | |
| 11 | find the idInParent of the | finalValue = subblock #idInParent |
| | subblock which feeds the final | |
| | output of the block | |
| | write code to calculate the | |
| | final value | |
| 12 | all calculation is now done, so | pop topFrame off of stack |
| | pop the stack | |
| 13 | return the final value | return finalValue |

Procedure 2: Exemplary pseudocode for compiling one block.
The pseudocode for the actual compiler is shown on the left. When it runs, it produces code in the target language which is shown on the right

Compiler steps three through six in Procedure 2 essentially define one function for each subblock of the block currently being compiled. These steps do not actually evaluate any of the blocks, they merely define how they should be evaluated when it comes time to do so. In steps four and five in Procedure 2, in the case of a storage look up, the target language code can just look up the value of the storage from the top of the stack, and in the case of a raw input (such as the “Pi” or “100” blocks in FIG. 2), the code simply returns what the user entered into the box. Step six handles the case of a normal subblock (either composite or non-composite). In this case, the compiler creates code using the name of the block and the inputs to the block. This code could be inserted directly as the target language pseudocode in step six, but instead, it is wrapped by the “doSubblock” function defined in step two.

The purpose of the doSubblock function in Procedure 2 is to avoid repeated invocations of the same code. If one result already has been calculated, and is then requested again by another block, the result does not need to be recalculated. The doSubblock function first checks in storedResults to see if the requested value has been calculated. If it has, it returns it without recalculating, and if it has not, it calculates the value, stores it, then returns it.

At this point, steps two through six have written target language code which defines how to evaluate each subblock of the current block, but none of this code has been called yet. The rest of the procedure writes target language code which actually evaluates the block. First, the stack needs to be pushed to reflect the current state of execution. This is done in step seven. Next, any storages present in this block need to be evaluated and have their values stored on the stack. This is done by steps eight, nine, and ten. Step nine handles the case of a storage being set from the output of another block. In this case, the value can be obtained by calling one of the functions defined in steps four through six. There is an edge case, handled in step ten, in which a storage could be set directly from the input of the block currently being compiled.

Finally, step eleven initiates the computation of the final result. It first finds which subblock feeds the output of the current block, and initiates evaluation of that subblock. This produces the final value that will ultimately be returned by the function being compiled.

To clean up, the stack frame that was pushed in step seven now needs to be popped back off the stack. This is done in step twelve. Step thirteen returns the final result. The overall effect of running the compiled target language code is that the final result is calculated and returned and the stack is left unchanged from what it was before the function was invoked.

In a typical implementation, running procedure 2 for all blocks in the diagram would produce code that can calculate the output of any block given its inputs. This may be necessary but not sufficient in order calculate the value of a particular output block. The reason is that the code created from procedure 2 only calculates the final output of a block, but separate code is needed to calculate the value of one of the output blocks specifically. Procedure 3 (see pseudocode, below) generates this code. It outputs target language code whose only purpose is to push the calculation far enough until it reaches ultimately to the requested output block.

Procedure 3, in a typical implementation, is generally executed once for each block starting from the top level diagram, proceeding next to the child block that ultimately contains the output, then the child of that block that ultimately contains the output, and finally down to the output block itself.

If procedure 3 is being run for the output block itself, then the only thing that needs to happen is that the input needs to be calculated and stored as a result. This is handled in step eleven (of procedure 2). If procedure 3 is being run for any other block, then the only thing that needs to happen is that the next block down enroute to the output lot needs to be executed. This is done in step twelve (of procedure 2).

| step | compiler pseudocode | target language pseudocode |
|---|---|---|
| 1 | write the function header for level | define function |
| | levelN | execBlock(levelN) (inputs): |
| 2-10 | same as procedure 2 | (same as procedure 2) |
| 11 | if this block is the output: | set |
| | the input to this block is the | calculatedResults(ancestry) = |
| | desired output value, so store it | input |
| 12 | else: | run execBlock (levelN + 1) |
| | find the idInParent of the child | |
| | block that ultimately contains the | |
| | output block | |

Procedure 3: This is the pseudocode for compiling one execution block.

Procedure 4 ties together the previously defined compiler procedures. It identifies the dependencies, compiles the blocks, compiles the execution steps, clears the stack, and initiates the computation for each requested output block, finally returning all of the desired results. The result from running procedure 4 is that a body of target language code is produced. This code, when run in the target language, produces all requested results.

| step | compiler pseudocode | target language pseudocode |
|---|---|---|
| 1 | write code to initialize | set calculatedResults to |
| | calculation | empty list |
| 2 | run procedure 1 | |
| | (blocksToCompile is now populated) | |
| 3 | for each block in blocksToCompile: | code for all required blocks |
| | run procedure 2 | |
| 4 | for each output block: | |
| 5 | for each block in the output's | code for all execBlocks |
| | ancestry: | |
| | run procedure 3 | |
| 6 | initiate the calculation for this | set stack to empty |
| | output | run execBlock 1 |
| 7 | return all output values | return calculatedResults |

Procedure 4:

This runs the entire compiler, producing the required code in the target language.

At this point, the target language code can be run (e.g., at 830 in FIG. 8) to produce the requested results. These calculated values (results) can then be recorded (at 832) (e.g., in the database 108), and returned (at 836) to the front end (e.g., the user interface 102) for display to the user. The system 100, according to the flowchart of FIG. 8, also resugars the diagram and results (at 834). In a typical implementation, the user interface 102 can determine which result should be shown in which output block by matching the ancestry of the result to the ancestry of the block (notice that the result was stored along with its ancestry in procedure 3, step eleven).

### Interpreter

The second method for calculating output values, represented in the flowchart of FIG. 8, is to interpret the diagram directly (e.g., with the interpreter, which is software executing on a computer processor). In this method, the interpreter typically maintains a stack, pushing and popping blocks itself, and performing all low-level operations (such as Plus and PrimeQ) itself when they are encountered. More particularly, in the illustrated implementation, the interpreter pre-loads the stack (at 838), performs an evaluation (at 840), and records the results (842), repeating this process (838, 840, 842) for each output.

One core of the interpreter is shown in procedure 5 steps one and two.

| step | interpreter pseudocode |
|---|---|
| 1 | define getInput(argNum): |
| | node1 = pop |
| | feederPort = find port that feeds requested input |
| | if feederPort is on a child block: |
| | push feederPort block |
| | val = getOutput(feederPort block name, feederPort argnum) |
| | pop |
| | else if feederPort is an input to current block: |
| | val = getInput(feederPort argnum) |
| | push node1 |
| | return val |
| 2 | define getOutput(block name, argNum): |
| | if this block is a raw block: |
| | return raw value |
| | else if this block is a non-composite block: |
| | if this block is a Plus block |
| | inputValue1 = getInput(1) |
| | inputValue2 = getInput(2) |
| | return (inputValue1 + InputValue2) |
| | // similar code for all other non-composite blocks |
| | // including third-party blocks |
| | else if this block is a composite block: |
| | feederPort = find port that feeds requested output |
| | push feederPort block |
| | val = getOutput(feederPort argnum) |
| | pop |
| | return val |
| 3 | clear calculatedResults |
| 4 | for each output: |
| 5 | clear stack |
| 6 | starting with the main diagram, push blocks onto the stack going |
| | down to and including the output |
| 7 | answerValue = getInput(1) |
| 8 | answerAncestry = current stack |
| | store (answerValue, answerAncestry) in calcualtedResults |
| 9 | return calculatedResults |

Procedure 5: The interpreter

In a typical implementation, at all times during the interpretation of a computational diagram, the stack is maintained. It keeps track of the current state of the evaluation. At any particular time, one particular block is the currently evaluating block, which is always the one represented by the top stack frame. Calling getInput, shown in step one, will return an input for the currently evaluating block. Calling getOutput with a particular block name will calculate that block's output, assuming that it is the currently evaluating block.

The getInput function, in Procedure 5, works by first popping the current stack frame off the stack, resulting in the parent being the new top frame. It then finds what is feeding the originally requested port. If it is being fed by a child block of the current block, then the interpreter pushes that block, gets its output by calling getOutput, and pops back. If it is being fed by an input of the current block, then the interpreter just calls getInput again to go up one level. Either way, the return value is calculated, the original block is pushed back onto the stack to keep the context correct, and the value is returned.

The getOutput function calculates the output of a given block assuming that it is already at the top of the stack. If the requested block is a raw input block, just return the value that the user typed into the block. If the requested block is a non-composite block, then do that block's operation. In the case of Plus, for example, get both of the inputs using getInput, add them, and return the sum. If the requested block is a composite block, find which of its children feeds the output, push that child onto the stack, call getOutput again with this new block, then pop it off and return the result.

In order to initiate evaluation for a particular output block, the interpreter pre-populates the stack by sequentially pushing blocks from the top level of the diagram down to the requested output block, along the output block's ancestry. This is done by steps five and six of procedure 5. Once the stack is ready, meaning that the requested output block is the currently evaluating block, all that's left to do is to call getInput(1). This initiates the whole computation, shown in step seven. After the computation completes, the stack will again indicate that the output block is the current block. Step eight then reads the ancestry from the stack and stores the just-calculated value, along with this ancestry, in calculatedResults. Steps five through eight repeat for each output block, and step nine returns all results.

Notice that the interpreter could be easily parallelized, even for a single output block, by running multiple stacks when possible. For example, when the interpreter reaches a Plus block, the then-current stack could be duplicated, with one copy proceeding to evaluate the first input to Plus and the other proceeding with the second input. When both of the inputs have returned, one of the stacks could be discarded and the other could proceed as usual. In this way, the interpreter can paralyze the computation whenever possible without the user having to be concerned with explicit parallelization.

### Additional Remarks

Functionalities associated with the user interface, evaluator, database, and target-language execution environment disclosed herein are provided by one or more computers/computer components. The one or more computers/computer components may include, for example, one or more processors, storage devices, memory having software stored therein that defines the abovementioned functionality, input and output (I/O) devices, peripherals, local buses, and/or local interfaces allowing for communication. The local interfaces can be, for example, but are not limited to, one or more buses or other wired or wireless connections. The local interfaces may have additional elements, such as controllers, buffers (caches), drivers, repeaters, and receivers, to enable communications. Further, the local interfaces may include address, control, and/or data connections to enable appropriate communications among the aforementioned components.

A processor can be any one or more hardware devices for executing software, particularly software stored in computer-based memory. The processor can be any custom made or commercially available single core or multi-core processor, a central processing unit (CPU), an auxiliary processor among several processors associated with the present computer, a semiconductor based microprocessor (in the form of a microchip or chip set), a macroprocessor, or generally any device, or combination of devices, for executing software instructions.

Memory can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, memory may incorporate electronic, magnetic, optical, and/or other types of storage media. Note that memory can have a distributed architecture, where various components are situated remotely from one another, but can be accessed by the processor.

Software typically defines functionality performed by the evaluator, and other system components, in accordance with the present invention. The software in the memory may include one or more separate programs, each of which contains an ordered listing of executable instructions for implementing logical functions of the evaluator. For example, the compiler, interpreter, and sugar/unsugar logic may be separate programs. Alternatively, the compiler, interpreter, and sugar/unsugar logic may be separate logical devices within a computer, as opposed to programs in the memory.

The memory may contain an operating system (OS) to control execution of programs within the system and provides scheduling, input-output control, file and data management, memory management, and communication control and related services.

The I/O devices may include input devices including, for example, but not limited to, a keyboard, mouse, scanner, microphone, etc. Furthermore, the I/O devices may include output devices including, for example, but not limited to, a printer, display, etc. Finally, the I/O devices may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the computer component(s) is(are) in operation, the processor(s) is(are) configured to execute the software stored within the memory, to communicate data to and from the memory, and to generally control operations of the computer pursuant to the software, as explained above. When the functionality of the computer is in operation, the processor is configured to execute the software stored within the memory, to communicate data to and from the memory, and to generally control operations of the computer pursuant to the software. The operating system is read by the processor, perhaps buffered within the processor, and then executed.

When the evaluator is implemented in software, instructions for implementing the evaluator can be stored on any computer-readable medium for use by or in connection with any computer-related device, system, or method. Such a computer-readable medium may, in some embodiments, correspond to either or both the memory or the storage device. In the context of this document, a computer-readable medium is an electronic, magnetic, optical, or other physical device or means that can contain or store a computer program for use by or in connection with a computer-related device, system, or method. Instructions for implementing the evaluator can be embodied in any computer-readable medium for use by or in connection with the processor or other such instruction execution system, apparatus, or device. Although the processor has been mentioned by way of example, such instruction execution system, apparatus, or device may, in some embodiments, be any computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the processor or other such instruction execution system, apparatus, or device. Such a computer-readable medium can be, for example, but is not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

In an alternative embodiment, where the evaluator (and/or other components) is implemented in hardware, it can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In some implementations, certain functionalities described herein may be provided by a downloadable software application (i.e., an app). The app may, for example, implement or facilitate one or more (or all) of the functionalities described herein as taking place at or in association with a website.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and described herein as occurring in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Graphical representation of the computational sequences can be implemented in a variety of ways. Typically it refers to any kind of visual representation where each functional component (e.g., each block) includes some element that is not solely text. In some instances, most of the graphical representation will appear as a group of shapes (i.e., blocks) connected together with lines.

The system can be modified in a variety of ways. For example, in some implementations, the system does not have a database. In those implementations, the storage may occur in some other memory. In some implementations (e.g., those that include an interpreter, as opposed to a compiler), the system may not have a target-language execution environment.

In various implementations, several of the components disclosed herein (e.g., the user interface, the target-language execution environment, and/or the evaluator, including the compiler or interpreter, and/or the sugar/unsugar module, etc.) are implemented through computer software being executed on one or more hardware components (e.g., one or more physical computer-based processors and/or memory storage chips and/or computer screen) in one (or more than one) physical housing.

Other implementations are within the scope of the following claims.

What is claimed is:

1. A computer-based visual programming system comprising:
a computer-based user interface that enables a user at a computer device to:
draw a plurality of blocks on a screen of the computer device, each block having an associated functionality; and
draw one or more lines to selectively connect the blocks together thereby creating a graphical representation of a computational sequence on the computer screen, wherein the lines determine an order for performing the functionalities associated with the blocks; and
a computer-based evaluator coupled to the computer-based user interface and configured to evaluate the graphical representation of the computational sequence so that one or more results from the computational sequence can be returned to the computer-based user interface for display on the computer screen, and
wherein the user interface visually displays each respective one of the results from the computational sequence on the computer screen and in association with a corresponding one of the blocks.

2. The computer-based system of claim 1, wherein the computer-based user interface further enables the user at the computer device to:
organize two or more of the blocks on the computer screen into a composite block, and link the two or more blocks in the composite block together,
wherein the composite block has a composite functionality that combines the functionalities of the two or more blocks inside the composite block.

3. The computer-based system of claim 2, wherein organizing the two or more blocks into the composite block comprises nesting or encapsulating blocks to any degree.

4. The computer-based system of claim 1, wherein the evaluator comprises:
a computer-based compiler that translates the graphical representation of the computational sequence into software code in a target language, and
wherein the software code in the target language is executed in a target-language execution environment to produce the one or more results.

5. The computer-based system of claim 1, wherein the evaluator comprises:
a computer-based interpreter that interprets the graphical representation of the computational sequence, directly, without translating the graphical representation into software code of a target language,
wherein the direct interpretation produces the one or more results.

6. The computer-based system of claim 1, wherein the evaluator comprises: a sugar/unsugar module that transforms one or more constructs in the graphical representation of the computational diagram that are not able to be evaluated directly, but instead must be transformed into one or more structures that can be evaluated directly.

7. The computer-based system of claim 1, wherein the user-interface enables the user at the computer device to provide a graphical element to designate one or more of the blocks as having mapping functionality, such that, given a list of items as an input to the block and a particular function associated with the block, mapping the function over the input list yields an output list in which each element represents the result of the function applied to a corresponding one of the items of the input list.

8. The computer-based system of claim 1, wherein the system is configured to identify, at the computer screen, any errors in the computational sequence, or graphical representation of the computational sequence.

9. The computer-based system of claim 1, wherein the user interface enables the user at the computer device to zoom in to or out of the graphical representation of the computational sequence on the computer screen.

10. The computer-based system of claim 1, wherein the user interface enables the user at the computer device to enter text-based software code, representing a coded functionality, directly into a particular one of the blocks, such that the particular block represents the coded functionality.

11. The computer-based system of claim 1, wherein the user interface provides a transform-to-code functionality for one or more of the blocks in the graphical representation of the computational sequence, wherein the user's selection of the transform-to-code functionality causes the system to produce software code based on the computational sequence represented in the one or more blocks.

12. The computer-based system of claim 1, wherein the user interface and the evaluator are coupled together at a single physical location.

13. The computer-based system of claim 1, wherein the user interface is implemented at a first location and the evaluator is implemented at a second location that is different than the first location, and wherein the user interface and the evaluator are coupled to one another via a communications network.

14. The computer-based system of claim 1, further comprising:
computer-based memory storage coupled to the user interface and the evaluator,
wherein the computer-based memory storage is configured to store the graphical representation of the computational sequence and any of the one or more results from the computational sequence.

15. The computer-based system of claim 1, wherein the associated functionality with each of the blocks comprises: performing a mathematical operation, acting as a source of data, presenting a particular one or more of the results from the computational sequence.

16. A computer-based method comprising:
enabling a user, with a computer-based interface at a computer device, to:
draw a plurality of blocks on a screen of the computer device, each block having an associated functionality; and
draw one or more lines to selectively connect the blocks together thereby creating a graphical representation of a computational sequence on the computer screen, wherein the lines determine an order for performing the functionalities associated with the blocks; and
evaluating the graphical representation of the computational sequence, with a computer-based evaluator, so that one or more results from the computational sequence can be returned to the computer-based user interface for display on the computer screen; and
visually displaying each respective one of the results from the computational sequence at the user interface on the computer screen, in association with a corresponding one of the blocks.

17. The computer-based method of claim 16, further comprising:
organizing two or more of the blocks on the computer screen into a composite block, and linking the two or more block in the composite block together, in response to a user prompt,
wherein the composite block has a composite functionality that combines the functionalities of the two or more blocks inside the composite block.

18. The computer-based method of claim 16, wherein the evaluator comprises:
a computer-based compiler that translates the graphical representation of the computational sequence into software code in a target language, wherein the software code in the target language is executed in a target-language execution environment to produce the one or more results; or
a computer-based interpreter that interprets the graphical representation of the computational sequence, directly, without translating the graphical representation into software code of a target language, wherein the direct interpretation produces the one or more results.

19. The computer-based method of claim 16, further comprising:
enabling the user at the computer device to provide a graphical element to designate one or more of the blocks as having mapping functionality, such that, given a list of items as an input to the block and a particular function associated with the block, mapping the function over the input list yields an output list in which each element represents the result of the function applied to a corresponding one of the items of the input list;
identifying, at the computer screen, any errors in the computational sequence, or graphical representation of the computational sequence;
enabling the user to zoom in to or out of the graphical representation of the computational sequence on the computer screen;
enabling the user at the computer device to enter text-based software code, representing a coded functionality, directly into a particular one of the blocks, such that the particular block represents the coded functionality; and/or
providing a transform-to-code functionality for one or more of the blocks in the graphical representation of the computational sequence, wherein the user's selection of the transform-to-code functionality causes the system to produce software code based on the computational sequence represented in the one or more blocks.

20. A non-transitory machine-readable storage medium storing instructions which, when executed, cause a computer-based processing device to:
display, at a computer screen of a computer device, a computer-based user interface that enables a user at the computer device to:
draw a plurality of blocks on a screen of the computer device, each block having an associated functionality; and
draw one or more lines to selectively connect the blocks together thereby creating a graphical representation of a computational sequence on the computer screen, wherein the lines determine an order for performing the functionalities associated with the blocks; and
evaluate the graphical representation of the computational sequence so that one or more results from the computational sequence can be returned to the computer-based user interface for display on the computer screen, and
wherein the user interface visually displays each respective one of the results from the computational sequence on the computer screen and in association with a corresponding one of the blocks.
